(19) United States
(12) Patent Application Publication
(10) Pub. No.: US 2011/0207204 A1
(43) Pub. Date: Aug. 25, 2011

(54) Method and apparatus for bioremediation of soils and sediments

(76) Inventor: Tommy Mack Davis, Spartanburg, SC (US)

(21) Appl. No.: 12/931,708

(22) Filed: Feb. 8, 2011

Related U.S. Application Data
(60) Provisional application No. 61/306,297, filed on Feb. 19, 2010.

(51) Int. Cl. B09C 1/10

(52) U.S. Cl. 435/262

(57) ABSTRACT

Biological plugs/conduits produce and distribute in situ a selected consortium of microorganisms appropriate to the treatment of a variety of soil and sediment contaminants. The bioplugs provide oxygen, air and/or other gases, nutrients, and a porous immobilization surface on which selected organisms are permitted to grow. Liquid such as water is used as a carrier to distribute the excess organisms into the environment surrounding the bioplug and deliver required nutrients. Biological plugs can be installed in a variety of locations including within a building slab, under buildings or active facilities, open fields, sludge ponds, river or creek beds, piles of excavated soils/sediments, and other related environments.

### CROSS REFERENCES TO RELATED APPLICATION

Priority of U.S. provisional patent application Ser. No. 61/306,297 filed Feb. 19, 2010, incorporated herein by reference, is hereby claimed.

### STATEMENTS AS TO THE RIGHTS TO THE INVENTION MADE UNDER FEDERALLY SPONSORED RESEARCH AND DEVELOPMENT

None

### BACKGROUND OF THE INVENTION

1. Field of the Invention

The present invention pertains to the bioremediation of ground, soils, sediment, sludge and/or water. More particularly, the present invention pertains to use of immobilized microbial bioreactor technology to bio-remediate ground, soils, sediment, sludge and/or water. More particularly still, the present invention pertains to the use of biological plugs, inserted directly into a contaminated zone, for biological reduction of contaminating materials in ground, soils, sediment, sludge, and/or water.

2. Brief Description of the Prior Art Ground, soils, sediment and/or ground water can become contaminated with various types of pollutants. For example, it is well known that “sludge”—a generic term for solids separated from suspension in a liquid—can contaminate large areas. Sludge typically contains significant quantities of interstitial water and/or other liquids, and often comprises residual, semi-solid material left over from industrial wastewater, sewage treatment processes, conventional drinking water treatment, and numerous other industrial processes.

Additionally, ground, soils, sediment and/or ground water can be contaminated with hydrocarbons and/or other chemicals. Frequently, such chemicals escape from a source into the surrounding environment. In many cases, hydrocarbons (such as, for example, gasoline or diesel fuel) can leak from underground storage tanks into the soils and other materials surrounding such tanks.

Frequently, remediation of such contamination requires excavation of large volumes of soils and sediment. Such soils or sediment are sometimes transported to another location, cleaned, transported back to the excavation site, and ultimately reintroduced at such site. In some cases, such contaminated soils or sediments are completely removed and replaced by totally different fill materials. Under either scenario, such remediation efforts can be extremely labor intensive, time consuming, and expensive.

Thus, there is a need for a method and apparatus for in situ remediation of contaminants and/or pollutants (including, without limitation, contaminants resulting from leaking underground storage tanks) in ground, soils, sediment and/or ground water that reduces or eliminates problems associated with conventional remediation methods. The method and apparatus must be safe, environmentally friendly and cost effective.

### SUMMARY OF THE PRESENT INVENTION

The biological plugs of the present invention produce and distribute, in situ, a selected consortium of microorganisms beneficially appropriate to the treatment of a variety of soil and sediment contaminants. The biological plugs of the present invention comprise miniaturized bioreactors that provide oxygen, air and other gases, nutrients, and a porous, high surface area immobilization surface on which beneficially selected organisms are able to grow. In the preferred embodiment, water is used as a primary carrier to distribute excess organisms into the environment surrounding the biological plug, and to deliver nutrients to the area(s) to be remediated.

The present invention comprises biological plugs or conduits, also sometimes referred to herein as “bioplugs”, utilizing immobilized microbial bioreactor technology. In the preferred embodiment, each bioplug comprises an outer housing; said outer housings are typically perforated cylindrical containers constructed of material(s) such as polyvinyl chloride (“PVC”), high density polyethylene (“HDPE”), stainless steel or other appropriate moldable material(s). If desired, the perforation pattern of the cylindrical container can be varied and specified for targeted delivery of microbe-laden liquid to contaminated zones within the soil/sediment strata to be treated.

The cylindrical containers of the present invention can be used to house inoculated biocarrier media. The biocarrier media can comprise numerous different substances (including, without limitation, porous diatomaceous earth and/or ceramic beads, for example) exhibiting desired properties and characteristics. In the preferred embodiment, both ends of such cylindrical containers are beneficially closed with removable end caps that can be removed to permit access to and manipulation of internal bioplug components when desired.

In the preferred embodiment, the bioplugs of the present invention utilize permanent immobilization of beneficial microbial organisms on such biocarrier. Such microbial organisms that are immobilized on the biocarrier media can include, without limitation, fungi, yeast, and/or bacteria. The organisms can be selected from previously cataloged and isolated microbes, with such microbes frequently being tailored to the particular environment and contaminants to be encountered.

Such immobilization allows for continuous in situ growth and export of a population of beneficial organisms, acclimated to the waste material present in the environment being treated. The organisms can also be isolated from site materials and cultured to enhance growth of organisms acclimated to site contaminants.

At least one microbubble generator (“MBG”) can be utilized to deliver air, pure oxygen, or other gases to the base of a bioplug to provide improved gas/oxygen saturation of the liquid nutrient carrier. In the preferred embodiment, said at least one MBG (for example, the MBG more fully disclosed in U.S. Pat. No. 5,534,143, which is incorporated herein by reference) is provided for periodic aeration and nutrient addition to a liquid column with bottom-up flow.

Flexible tubing can be used to deliver gases to MBG(s) present within such bioplug cylinders; in the preferred embodiment, such tubing is non-perforated (i.e., continuous) from the surface to a connection point at the MBG. In addition to delivery of gases, flexible tubing can also be used to deliver liquid nutrients; when a separate length of flexible tubing is used to deliver nutrients, such tubing can be perforated throughout its length or at specified locations corresponding to perforations in the outer container.

During operation of the bioplugs of the present invention, beneficial organisms migrate away from the inoculated biocarrier surface via added water and begin to colonize the surrounding environment, in many cases utilizing the contaminant(s) present in such environment as the primary carbon source for metabolism and energy generation.

Bioplug configuration can be specifically tailored to each particular treatment site. For example, bioplugs can exhibit varying lengths, and perforation(s) can be situated at different locations on the plugs to optimize treatment performance. Further, such bioplugs can be installed in a variety of locations including, without limitation, within a building slab, under buildings or active facilities, open fields, sludge ponds, river or creek beds, piles of excavated soils/sediments, and other environments to be remediated.

In the preferred embodiment of the present invention, bioplugs are installed (and oriented horizontally, vertically or at a beneficial angle) directly into a contaminated zone in soil, sediment, or sludge to biologically reduce or remediate contaminant materials present in soil, sediment, sludge, and groundwater. As part of such treatment method, bipoplug length can be varied as desired. Further, at greater depths, such bioplugs can be “piggy backed” on one another to allow for ease of handling during the installation phase; that is, logistically manageably-sized bioplugs can be connected to one another via extensions of gas and liquid nutrient tubing to allow for movement and transfer of water, nutrients and oxygen between the inserted sections.

Bioplugs can be installed such that the upper end of each bioplug is flush with or below the surface of the ground; such below-ground installation allows for greater access to the surface of the treatment zone, including movement of people and vehicles over the installed system. Alternatively, if desired, the upper portion of each bioplug can be positioned so that it partially extends above ground for easier access and/or manipulation. The upper portions of bioplugs of the present invention can include an accessible box that contains a bioplug head, valves and tubing connections used for monitoring and manipulation of the particular bioplug. Alternatively, bioplugs can also be inserted within existing wells, monitoring wells and/or access tubes having openings for access to the surrounding contaminated soils. Further, if desired, supply tubing can also be installed below ground.

Generally, characteristics of the surrounding environment such as porosity, permeability and moisture content can impact spacing and patterns for bioplug installation. Among other things, such characteristics can significantly impact area of influence overlap between bioplugs. Further, the depth of material(s) to be remediated can also impact the spacing and pattern of bioplug installation.

Bioplugs can be operated aerobically via introduction of oxygen-based fluids to such bioplugs including, without limitation, any liquid medium present in such plugs. Bioplugs can also be operated anaerobically via introduction of non-oxygen based fluids to such bioplugs, or by limiting or ceasing addition of all gases to such bioplugs.

Bioplug spacing and pattern can be extended or widened to cover a broad area, also known as a biotrench or biofence, wherein a number of bioplugs have substantially the same material design and functional parameters. Nutrients for the field-placed bioplugs can be supplied via specified tanks for gases and water-based nutrients, or from a full scale IMBR system acting as a microbial generation unit. Further, a teamed bioplug and IMBR system can be utilized for retrieval and treatment of contaminated groundwater followed by reinjection of the water to the site via bioplugs.

All organic and substituted organic compounds including but not limited to petroleum hydrocarbons and halogenated hydrocarbons can be reduced in situ using bioplug technology. Organic contaminants to be reduced using bioplug technology can be straight chained, ringed, multi-ringed or a combination. Moreover, inorganic materials such as metals can also be removed via sequestration and or utilization by appropriate microbial consortia.

### BRIEF DESCRIPTION OF THE DRAWINGS

The foregoing summary, as well as the following detailed description of the preferred embodiments, is better understood when read in conjunction with the appended drawings. For the purpose of illustrating the invention, the drawings show certain preferred embodiments. It is understood, however, that the invention is not limited to the specific methods and devices disclosed.

FIG. 1 depicts a side sectional view of a bioplug assembly installation of the present invention.

FIG. 2 depicts an overhead perspective view of a soil remediation installation employing multiple bioplug assemblies of the present invention.

FIG. 3 depicts a side sectional view of a bioplug assembly installation used to remediate underground contaminants.

### DETAILED DESCRIPTION OF A PREFERRED EMBODIMENT OF THE INVENTION

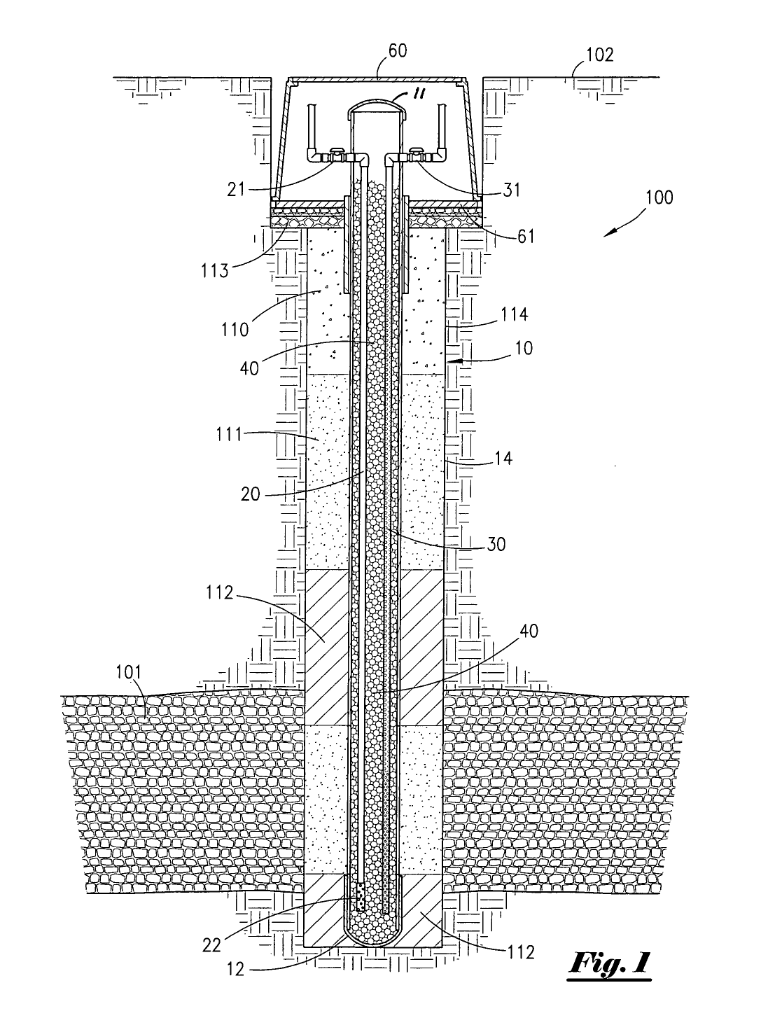

FIG. 1 depicts a side sectional view of bioplug assembly 10 of the present invention in an underground installation having a substantially vertical orientation. In the preferred embodiment, bioplug assembly 10 comprises substantially cylindrical container member 14 constructed of material(s) appropriate for the environment and contaminants to be treated. By way of illustration, but not limitation, said substantially cylindrical container member 14 can be manufactured of stainless steel, coated steel, polyvinyl chloride (PVC), high density polyethylene (HDPE), or virtually any other material(s) or combinations thereof exhibiting desired characteristics. It should also be observed that the shape and dimensions of container member 14 (including, without limitation, length, diameter and wall thickness) can vary depending on the intended use for a bioplug assembly. In most cases, container member 14 is perforated, frequently at depth(s) corresponding to depth(s) at which contaminants will be encountered for reasons described more fully below.

As depicted in FIG. 1, container member 14 is at least partially installed at least partially subterraneously within ground 100, and can be used to beneficially treat contaminants present within contaminated strata 101. By way of illustration, but not limitation, it is to observed that contaminated strata 101 can contain sludge or other sub-surface contaminant to be remediated. In the preferred embodiment, bore hole 114 is drilled or otherwise formed in ground 100, and container 14 is inserted within bore hole 114. Although not required in all cases, member 14 can be secured within bore hole 114 using various materials such as, for example, cement layer(s) 110, coarse sand (or gravel) 111 or clay (such as, for example, bentonite) 112. If desired, a transitional layer can also be formed near the upper end of bioplug assembly 10 using washed stone 113. Head box 60 can be installed on head box base 61 to protect the upper portion of said bioplug assembly 10 from the elements and/or tampering.

In the preferred embodiment, container member 14 of bioplug assembly 10 of the present invention is beneficially sealed at its upper end with removable upper end member 11 and at its lower end with removable lower end member 12. Said removable end members 11 and 12 can be affixed to the ends of container member 14 using many different known means including, without limitation, threaded connections. Said removable end members 11 and 12 can be removed as desired in order to permit access to the internal portion of container member 14, as well as placement of aeration and nutrient tubing and at least one micro bubble generator (MBG) at or near the bottom of said container member 14.

Gas supply line 20 and nutrient supply line 30 each extend from outside sources to the interior of container member 14. Gas supply line 20 and nutrient supply line 30 are each beneficially constructed of flexible tubing (such as, for example, ¼″ OD stainless steel tubing); if desired, said gas supply line 20 and nutrient supply line 30 can extend substantially along the entire length of container member 14. In the preferred embodiment, gas supply line 20 is continuous (i.e., not perforated), equipped with surface control valve 21, and the distal end of such tubing is connected to diffuser 22 or at least one MBG (not shown in FIG. 1). Also in the preferred embodiment, nutrient supply line 30 is perforated along all or part of its length, and is equipped with surface control valve 31.

In operation, gas supply line 20 can deliver air, oxygen and/or other gases from an external source (such as, for example, an air compressor, gas tank or the like situated at the surface) to the base of bioplug assembly 10 in order to provide improved gas/oxygen saturation of liquid nutrient carrier(s) within said bioplug assembly 10. In the preferred embodiment, at least one MBG (for example, the MBG more fully disclosed in U.S. Pat. No. 5,534,143, which is incorporated herein by reference) can be installed at or near the base of bioplug assembly 10 and used for periodic aeration and nutrient addition to a liquid column with bottom-up flow within said bioplug assembly 10. Similarly, nutrient supply line 30 can be used to supply nutrients from an external source to the interior of container member 14; said nutrient supply line 30 can either be perforated along its length (as depicted in FIG. 1) or non-perforated with an opening near the base of container member 14, depending upon desired nutrient distributions within bioplug assembly 10. Further, in certain applications, said nutrient supply line 30 may be perforated only at desired interval(s) along the length of said supply line 30 corresponding to desired locations along the length of bioplug assembly 10.

Microbial generation is beneficially accomplished by bioplug assembly 10 of the present invention through the use of immobilized microbe bioreactor (“IMBR”) technology in which microbes are immobilized on a desired substrate. In the preferred embodiment, such IMBR technology beneficially utilizes at least one bio-carrier medium 40 inoculated with desired microbes; said at least one bio-carrier medium 40 can include, without limitation, porous diatomaceous earth solids (such as described in U.S. Pat. No. 4,859,594 and U.S. Pat. No. 4,775,650, both of which are incorporated herein by reference). Each bioplug can also contain varying amounts of inert fused silica extruded as controlled porosity ceramic biocarrier beads. Said at least one biocarrier medium 40 can support microorganisms added directly into bioplug assembly 10, or can be inoculated prior to loading of said at least one biocarrier medium 40 into container member 14.

In the preferred embodiment, at least one bio-carrier medium 40 is inoculated by being beneficially coated with a thin film of chitin or other substance, and yeast cells or other beneficially selected microbes are immobilized on the surface(s) of such at least one bio-carrier medium 40. Additionally, as noted above, at least one MBG immobilized cell reactor (for example, the MBG more fully disclosed in U.S. Pat. No. 5,534,143, which is incorporated herein by reference) can be provided for periodic aeration and nutrient addition to a liquid column with bottom-up flow in certain of said IMBR reactor(s). By promoting in situ growth of beneficial microbial populations, bioplug assembly 10 of the present invention promotes microbial growth. Using compressed gas, a low-level pressure gradient can be created which helps maintain gas flow throughout bioplug assembly 10. Such pressure gradient also aids in moving aerated, nutrient laden water out of container member 14 and into the surrounding environment, including those portion(s) of the surrounding environment containing contaminant(s) to be remediated.

Although installation of bioplug assembly 10 can take many forms, in a preferred embodiment installation can follow the basic steps of drilling or otherwise creating bore hole 114 to a desired depth within the ground or other stratum, inserting container member 14 in said bore hole 114 with attached gas supply line 20 and nutrient supply lime 30, adding fine gravel or sand to the annular space around the external surface of container member 14 to stabilize such container member 14 within said bore hole 114, and to allow for easier outflow of liquid that supports microbes, nutrients and gases. At least one clay (typically bentonite) sealing layer 112 can be provided around the outer surface of container member 14 at varying locations along the length of said container member 14 to prevent axial flow or channeling of fluids (including, without limitation, surface water) along the outer surfaces of container member 14.

In some installations, a cement section 110 can also be added near the upper portion of bore hole 114, prior to installation of head box 60, with a layer of washed stone 113 to allow for stabilization of said head box, especially when used in a flush-to-ground installation. Head box 60 can also be made of varying materials including, but not limited to, steel and/or plastic exhibiting desired characteristics. As depicted in FIG. 1, head box 60 can be installed flush with upper surface 102 and over the top portion of bioplug assembly 10. In the preferred embodiment, head box 60 is large enough to encase upper portion of bioplug assembly 10, as well as any associated valving (such as, for example, valves 21 and 31) and fittings. Addition of biocarrier media, attachment of valves for control of gas and nutrient flow within bioplug assembly 10, and capping of container 14 will typically complete installation of bioplug assembly 10. Alternatively, bioplug assemblies can also be installed to be free standing at the ground surface for ease of monitoring, manipulation and access, or flush with the surface into which they are installed to allow for continued vehicular or pedestrian access in area(s) where they are installed.

As noted above, a support network of tubing may be included for separate air and liquid nutrient supply. Such tubing can be installed beneath upper surface 102 of ground 100 to allow for unrestricted vehicular or pedestrian access to the treatment location. If desired, such tubing can be protected with a rigid covering. Additionally, trenching (typically 6-10 inches below ground surface 102) allows for unfettered vehicular and/or pedestrian access to the site without damage to air and nutrient lines supplying bioplug assembly 10.

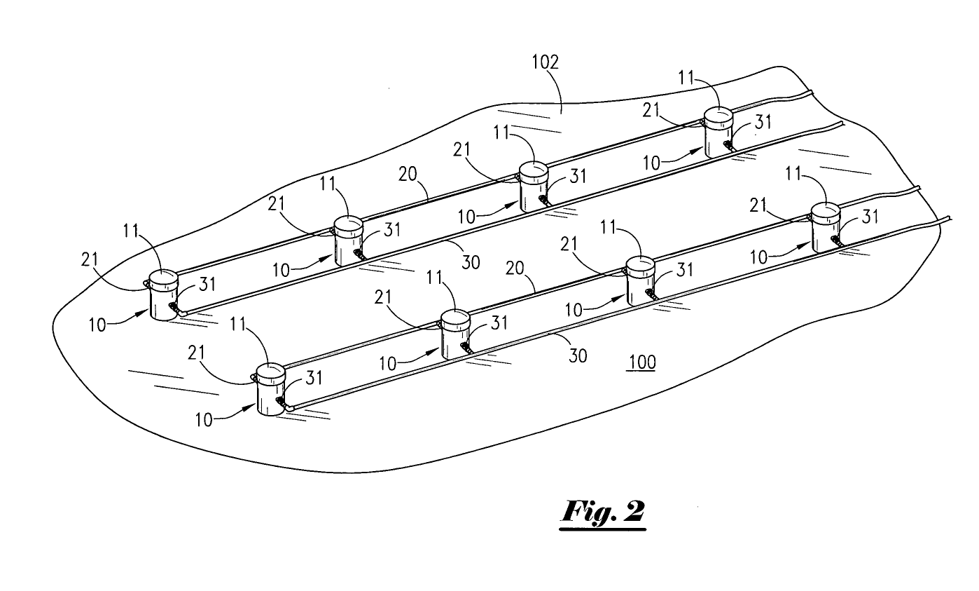

FIG. 2 depicts an overhead perspective view of a soil remediation installation of the present invention comprising multiple bioplug assemblies 10. As depicted in FIG. 2, multiple bioplug assemblies 10 are partially installed within ground 100, such that a portion of each such bioplug assembly 10 extends above upper surface 102 of ground 100. Gas supply line 20 and nutrient supply line 30 each extend from outside source(s) to the interior portions of each bioplug assembly 10. In the preferred embodiment, gas supply line 20 and nutrient supply line 30 are each beneficially constructed of flexible tubing (such as, for example, ¼″ OD stainless steel tubing). Further, in the preferred embodiment, gas supply line 20 is equipped with surface control valve 21, while nutrient supply line 30 is equipped with surface control valve 31, leading into each bioplug assembly 10.

Soil or other sub-stratum conditions will often dictate ease of installation and modifications to installation protocols for each bioplug assembly, which can include a removable outer drill casing left in place until the end of the installation to prevent immediate impact of fluidized soils/sediments on a slotted bioplug container before addition of biocarrier media and activation of the system where aeration will create a slight pressure gradient that will prevent movement of soils/sediment into such bioplug assemblies.

Further, bioplug assembly placement and diameter of influence is frequently dictated by soil characteristics (including, without limitation, porosity and permeability), available moisture, and depth of material to be remediated. Soils with greater porosity and permeability will typically allow easier movement of gases and microbial-laced liquid from a bioplug assembly into surrounding soils. Conversely, compacted soils or soils with low porosity will frequently not permit easy movement of fluids through the ground. Thus, each bioplug assembly will often have a diameter of influence dictated by the movement rate of the liquid exported from the bioplug. It is to be observed that biosurfactant action of microbes over time will often increase soil porosity, at least in the area in close proximity to a bioplug assembly, and allow for improved microbial migration.

In some locations, monitoring wells exist in locations conducive to remediation with the export of nutrient and microbial laden liquid(s) from the screened portion of the well. In such cases, a properly sized bioplug assembly and accompanying aeration and nutrient tubing, as well as other associated equipment, can be inserted within such monitoring well(s). Pumps associated with former monitoring well activities can be removed or deactivated prior to bioplug assembly activation.

In order for the beneficial microorganisms in the bioplug assemblies to grow quickly, oxygen/air/other gases, water and nutrients may beneficially be provided. Gases are typically provided through a network of pipes connecting the bioplugs from an attached generator, or through an injection system in which a generator injects gases into the bioplugs (typically at a maximum pressure of 50 to 60 psi; however, it is to be observed that said pressure may vary).

Water addition often depends upon rainfall in the vicinity of bioplug assemblies. In an area of high rainfall, water addition is typically limited to the amount required to introduce nutrients to the bioplug assemblies. Initial nutrient additions (such as time release materials) can beneficially add a large dose of nitrogen and phosphorus at initial stages, and permit export with water flows either through water addition, excess rainfall, or high groundwater columns as influenced by an artesian effect that can be produced by aeration from a microbubble generator. Water is generally delivered to bioplug assemblies through interconnecting pipes attached to a main water source. When a MBG is not available, gases can be provided from aeration of water/nutrient source(s).

In many instances, water must be provided regularly to maintain high oxygen (or other gas) content. In most cases, soil should be kept moist, but standing water should be avoided unless continuous oxygenation is assured in the case of aerobic systems. A dry fertilizer dissolved in water or other fluid or liquid fertilizer can be used to provide nitrogen and phosphorous to the soils. In the preferred embodiment, a carbon, nitrogen, and phosphorous ratio of 100:10:1 should be maintained as nearly as is possible for optimum remediation rates. Carbon can be added depending upon the carbon source in the material to be degraded. Easily degradable carbon can be added to sites where the material is known to be resistant to microbial metabolism.

Addition of inoculated media within a bioplug assembly often necessitates the immediate activation of such system. Gas and liquid flow are typically adjusted based upon distance from gas and liquid sources as well as concentration of contaminant(s) to be remediated at a particular bioplug assembly location. Soils and water sampling at the time of installation and system activation can be important for the creation of a baseline dataset for long term monitoring of contaminant degradation. Periodic checks for gas and liquid flow, soil and groundwater concentrations of contaminants, and maintenance of bioplug assembly headers should be performed to keep the system at peak efficiency. Weather conditions should also be monitored as well for proper adjustment of gas and water flow rates.

Bioplug assemblies of the present invention can be utilized in a variety of locations including, without limitation, open fields, sludge ponds, creek and river beds, accumulations of excavated soil or sediment, through facility slab(s), or under building foundation(s). In some instances, vertical installation can require breaking of foundations from within a facility; directional drilling for horizontal placement of a bioplug assemblies can allow foundations to remain undisturbed.

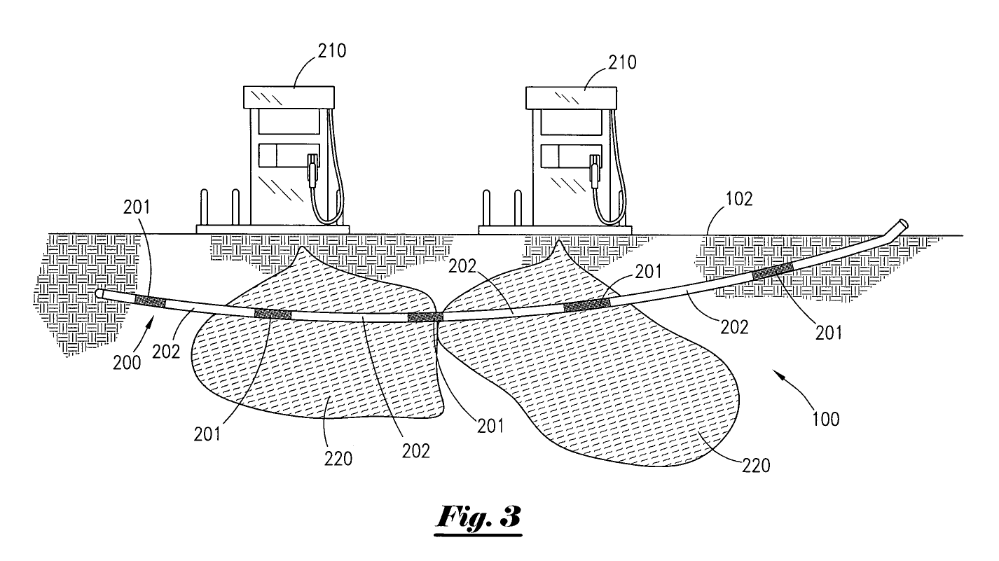

FIG. 3 depicts a side sectional view of an example bioplug assembly installation used to remediate underground contaminants. As depicted in FIG. 3, bioplug assembly 200 is elongate and extends substantially horizontally through ground 100, as well as through underground contaminants 220 (for example, hydrocarbons leaked from underground storage tanks or surface gas pumps 210). Bioplug assembly 200 has solid/continuous outer casing sections 202, as well as perforated or slotted sections 201 to permit outflow of beneficial microbial population(s) in areas having the most contaminants. Bioplug assembly 200 functions in substantially the same manner as vertical biolplug assembly 10 as depicted in FIG. 1.

After site cleanup standards have been achieved, bioplug assemblies can be removed, or left in place and the system shutdown. When said bioplug assemblies are left in place, water is permitted to drain from the system. In an oxygenated system, gas flow can be beneficially shut down as the final step to ensure reduction of stress on the media-attached organisms as they achieve dormancy. A dormant system can be easily reactivated as in the case of a new spill or leak by addition of appropriate gases and liquid nutrients to the bioplug assemblies of the present invention.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. A method of treating waste in soils or sediment comprising:
a. inoculating at least one carrier medium with at least one microbial population, wherein said at least one microbial population is immobilized on a surface of said at least one carrier medium;
b. placing said at least one inoculated carrier medium within a porous container;
c. inserting said porous container, at least partially, in said soil or sediment; and
d. propagating said at least one immobilized microbial population, wherein microbial organisms exit said porous container.

2. The method of claim 1, further comprising the step of boring a hole in said soil or sediment for receiving said porous container.

3. The method of claim 1, further comprising the step of supplying at least one nutrient to said at least one microbial population.

4. The method of claim 1, further comprising the step of supplying oxygen to said at least one microbial population.

5. The method of claim 1, wherein said at least one microbial population is spread throughout said porous container by gas bubbles diffusing through a liquid in said container.

6. A method of treating waste in soils or sediment comprising:
a. inoculating at least one carrier medium with at least one microbial population, wherein said at least one microbial population is immobilized on a surface of said at least one carrier medium;
b. placing said at least one inoculated carrier medium within a porous container;
c. inserting said porous container, at least partially, in said soil or sediment;
d. diffusing gas bubbles through a liquid in said container using a micro bubble generator; and
e. propagating said at least one immobilized microbial population, wherein microbial organisms exit said porous container.

7. The method of claim 6, further comprising the step of boring a hole in said soil or sediment for receiving said porous container.

8. The method of claim 6, further comprising the step of supplying at least one nutrient to said at least one microbial population.

9. The method of claim 8, wherein a length of tubing extends from the inside of said porous container to a nutrient source located outside said porous container.

10. The method of claim 6, further comprising the step of supplying oxygen to said at least one microbial population.

11. The method of claim 10, wherein a length of tubing extends from the inside of said porous container to an oxygen source located outside said porous container.

12. The method of claim 5, wherein said microbial organisms exiting said porous container are conveyed in liquid.
